(19) United States
(12) Patent Application Publication
(10) Pub. No.: US 2010/0141685 A1
(43) Pub. Date: Jun. 10, 2010

(54) DISPLAY APPARATUS AND CONTROL METHOD THEREOF

(75) Inventor: Ki-wan LEE, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si, (KR)

(21) Appl. No.: 12/569,054

(22) Filed: Sep. 29, 2009

(30) Foreign Application Priority Data
Dec. 10, 2008 (KR) 10-2008-0125486

(51) Int. Cl. G09G 5/36; G09G 5/00

(52) U.S. Cl. 345/667; 345/545; 345/682; 345/502

(57) ABSTRACT

A display apparatus displaying an image on a screen according to a turn-on signal is provided. The display apparatus includes a display unit, and a control unit which performs a boot up of the display apparatus and displays a pre-stored image separately if the display apparatus is turned on. Accordingly, the user can determine that the boot up is in progress.

### CROSS-REFERENCE TO RELATED APPLICATIONS

This application claims priority from Korean Patent Application No. 10-2008-125486, filed on Dec. 10, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to a display apparatus and a control method thereof, and more particularly, to a display apparatus which displays an image on a screen according to a turn-on signal and a control method thereof.

2. Description of the Related Art

Display apparatuses such as a D-TV, BLU-RAY Disc Player, and a DVD player are basically equipped with a display screen to output multimedia data which has been signal-processed.

If such a conventional display apparatus is powered on, it does not process an image until a system is initialized and stabilized and thus the screen stays in an inactive state for about 3 to 10 seconds depending on the type of apparatus.

That is, only after a code and other image have been read out from a flash memory and have been written onto a main memory and a security process for safe booting has been performed, the display apparatus is booted and an image is displayed on the screen.

Recently, since the operating system (OS) has a tendency to become larger due to the various applications and additional functions, it takes much time to copy various program codes from the flash memory to the main memory and thus a long time is required until the system is completely booted.

Therefore, a user should wait in the inactive state of the screen for a predetermined time after the display apparatus has been powered on, and thus, the user often misunderstands that there occurs an error in the apparatus or should wait until the apparatus is booted without monitoring the booting condition.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Exemplary embodiments of the present invention provide a display apparatus which displays an image on a screen according to a turn-on signal to allow a user to be aware of that normal booting is in progress and a control method thereof.

Consistent with an aspect of the present invention, a display apparatus comprises a display unit, and a control unit which performs a booting job for the display apparatus and a display job of a pre-stored image separately if the display apparatus is turned on.

The control unit may comprise a CPU which initiates the booting job if the display apparatus is turned on, a storage unit which stores the image, a signal generation unit which generates a synchronization signal if the display apparatus is turned on, and a graphic process unit which graphic-process the image stored in the storage unit according to the synchronization signal and provides the image to the display unit.

The graphic process unit may enlarge or reduce a size of the image and provide the image to the display unit.

The image may include at least one of a letter, a figure, and a background.

The signal generation unit may generate a signal regarding at least one of background information of a screen on which the mage is to be displayed and position information indicating where the image is to be displayed on the screen, and may provide the signal to the graphic process unit.

The image may be a logo image.

Consistent with an aspect of the present invention, a control method of a display apparatus comprises turning-on the display apparatus; and performing a booting job for the display apparatus and a display job of a pre-stored image separately.

The display job of the pre-stored image may comprise generating a synchronization signal if the display apparatus is turned on, and graphic-processing and displaying the pre-stored image according to the synchronization signal.

The graphic-processing operation may enlarge or reduce a size of the image.

The image may include at least one of a letter, a figure, and a background.

The synchronization signal generating operation may generate a signal regarding at least one of background information of a screen on which the image is to be displayed and position information indicating where the image is to be displayed on the screen.

The image may be a logo image.

Accordingly, the user can see the logo image at the same time of turning on the display apparatus and acknowledges that the display apparatus is being normally booted by seeing the logo image.

Additional and/or other aspects and advantages of the invention will be set forth in part in the description which follows and, in part, will be obvious from the description, or may be learned by practice of the invention.

### BRIEF DESCRIPTION OF THE DRAWING FIGURES

The above and/or other aspects of the present invention will be more apparent by describing certain exemplary embodiments of the present invention with reference to the accompanying drawings, in which:

FIG. 1 is a block diagram illustrating a display apparatus consistent with an exemplary embodiment of the present invention;

FIG. 2 is a detailed block diagram illustrating the display apparatus of FIG. 1;

FIGS. 3A and 3B are views illustrating a method for displaying an image consistent with an exemplary embodiment of the present invention;

FIGS. 4A and 4B are views illustrating a method for displaying an image consistent with another exemplary embodiment of the present invention;

FIG. 5 is a flowchart illustrating a control method of a display apparatus consistent with an exemplary embodiment of the present invention; and

FIG. 6 is a flowchart illustrating the control method of the display apparatus of FIG. 5 in detail.

### DETAILED DESCRIPTION OF THE EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

FIG. 1 is a block diagram illustrating a display apparatus consistent with an exemplary embodiment of the present invention. Referring to FIG. 1, a display apparatus 100 comprises a display unit 110 and a control unit 120.

The display apparatus 100 may be implemented as an apparatus capable of displaying multi-media contents, and includes a D-TV, a BLU-RAY disc player (BDP), a digital versatile disc player (DVDP), and a video cassette recorder (VCR).

The display unit 110 functions to display an image provided through the display apparatus 100 on a screen and may be implemented as a cathode ray tube (CRT), a liquid crystal display (LCD), a thin film transistor liquid crystal display (TFT-LCD), a plasma display panel (PDP), a flexible display, or a head mounted display (HMD).

The control unit 120 functions to control entire operation of the display apparatus 100. More particularly, if the display apparatus 100 is turned on (powered on), the control unit 120 proceeds with a boot up of the display apparatus 100 and a display of a pre-stored image separately. The pre-stored image may be a logo image (trademark or commercial image) of a set manufacturer. Also, the pre-stored image may be a symbol, an emblem, a mark, or an ideogram.

Hereinafter, for the convenience of explanation, the pre-stored image is a logo image of a set manufacturer.

More specifically, if the display apparatus 100 is turned on, the control unit 120 generates a control signal to proceed with the boot up and a control signal to display the pre-stored logo image separately, and controls the logo image to be displayed on the display unit 110 regardless of the boot up.

The control unit 120 may perform a graphic process with respect to the pre-stored logo image and provide the graphic-processed image to the display unit 110. The graphic-process may be a process of enlarging or reducing the pre-stored image and a process of generating a background image. That is, the pre-stored logo image may be a complete image including a background or a partial image, such as a figure and a letter, excluding a background.

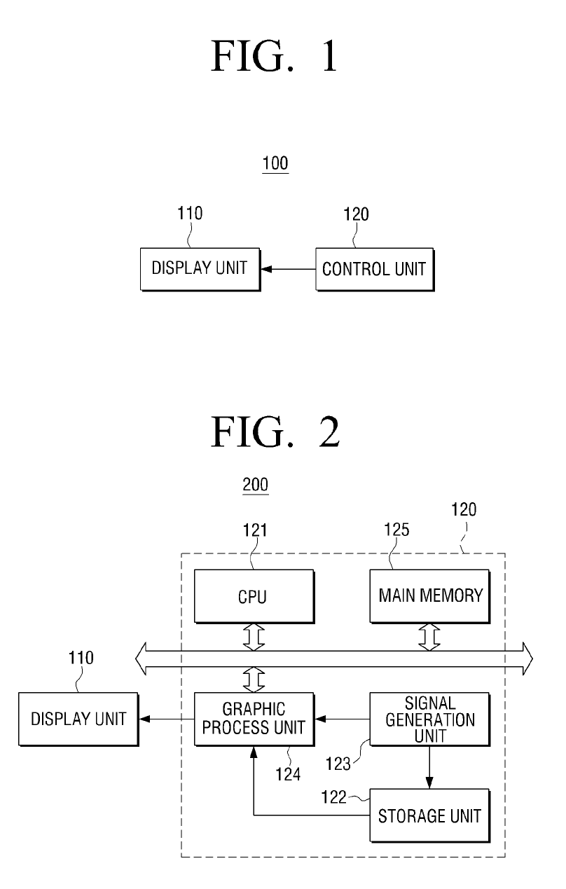

FIG. 2 is a detailed block diagram of the display apparatus of FIG. 1.

Referring to FIG. 2, a display apparatus 200 comprises a display unit 110 and a control unit 120. The control unit 120 comprises a CPU 121, a storage unit 122, a signal generation unit 123, a graphic processing unit 124 and a main memory 125. For convenience of explanation, the same elements as those of FIG. 1 will not be described.

The display unit 110 functions to display an image provided through the display apparatus 200 on the screen. The display unit 110 may output a logo image in a progressive method or an interlaced method. Briefly, the progressive method projects an image onto a screen in the unit of single line, whereas the interlaced method projects an odd numbered image and then projects an even numbered image.

If the display apparatus 200 is turned on, the control unit 120 proceeds with a boot up of the display apparatus 200 and a display of a pre-stored image separately. The pre-stored image may be a logo image (trademark or commercial image) of a set manufacturer. The pre-stored image may be a symbol, an emblem, a mark, or an ideogram.

Hereinafter, the pre-stored image is a logo image of a set manufacturer for the convenience of explanation.

The control unit 120 comprises the CPU 121, the storage unit 122, the signal generation unit 123, the graphic processing unit 124, and the main memory 125.

The CPU 121 initiates the boot up if the display apparatus 200 is turned on. More specifically, the CPU 121 loads a boot code, a program code, or other image onto the main memory 123 and then performs various operations to initiate the system and boot the display apparatus 200. The main memory 125 may be implemented as a dynamic random access memory (DRAM), and more particularly, as a DDR, a DDR2, a RD, or a SD.

For example, the control unit 120 may further comprise a boot loader (not shown) to execute a booting program, a phase locked loop (PLL) (not shown), and a clock signal loop (not shown). If the display apparatus 200 is turned on, the controller 120 enables the PLL and the clock signal loop to arrange a frequency source signal used in the display apparatus 200. The PLL adds speed control information to the signal used in the display apparatus 200 and transmits the signal. Each component fixes its own local clock based on the speed control information included in the signal to extract a signal component. Accordingly, the frequency source signal is stabilized without changing depending on the factors such as loop interference due to the PLL and the clock signal loop, temperature, and external device interference.

The controller 120 checks the function statuses of the respective components by executing the booting program through the boot loader and loads the operating system onto the main memory 125, thereby booting the display apparatus 200.

After that, the controller 120 controls respective components to process a video signal input from the outside and display it on the display unit 110.

The storage unit 122 stores the logo image which is displayed when the display apparatus 200 is turned on. The storage unit 122 may be realized as a non-volatile memory (NVM) or NVRAM, and more particularly, as a ROM and a flash ROM. The logo image stored in the storage unit 122 may be stored in various graphic formats. For example, the logo image may be stored in the format such as 1 bpp (bit per pixel), 2 bpp, 4 bpp, 8 bpp, 16 bpp, 32 bpp.

The storage unit 122 may store a complete logo image or a partial image which is displayed when the display apparatus 200 is turned on. For example, the logo image displayed when the display apparatus 200 is turned on may include at least one of a letter, a figure, and a background, and the storage unit 122 may store only a letter or a figure. In this case, the background is generated and displayed by the signal generation unit 123 and the graphic processing unit 124, which will be described later.

The image to be stored to the storage unit 122 may be compressed in various compression methods. For example, the image may be compressed in a lossless compression method such as run length encoding (RLE) (LZW algorithm). Also, the image may be compressed in runtime length decoding (RLD) or entropy compression methods.

If the display apparatus 200 is turned on, the signal generation unit 123 generates a control signal to control the storage unit 122 and the graphic processing unit 124 regardless of the CPU 121.

More specifically, if the display apparatus 200 is turned on, the signal generation unit 123 generates a synchronization signal to drive the storage unit 122 and the graphic processing unit 124. Accordingly, it is possible to display the logo image separately from the boot up of the display apparatus 200.

The graphic processing unit 124 is driven according to the synchronization signal generated by the signal generation unit 123, and graphic-processes the image stored in the storage unit 122 and provides the graphic-processed image to the display unit 110. More specifically, the graphic processing unit 124 enlarges or reduces the logo image stored in the storage unit 122 and provides the image to the display unit 110.

For example, the graphic processing unit 124 comprises a scaler (not shown) to scale the logo image which has been compressed and stored in consideration of the capacity of the storage unit 122. For example, the scaler (not shown) interpolates image data according to various resolutions such as VGB, SVGA, XGA, SXGA, UXGA, HD-TV and generates a new image suitable for the screen size. Besides, the graphic processing unit 124 may perform gamma correction, on-screen display, filtering, and brightness/contrast adjustment.

Also, the signal generation unit 123 generates signals regarding background information of the screen on which the logo image stored in the storage unit 122 is to be displayed, position information regarding where an image is to be displayed on the display screen, and size information of the display screen, and provides the signals to the graphic processing unit 124.

The graphic processing unit 124 graphic-processes the background image based on the background information provided from the signal generation unit 123, or scales the compressed image based on the size information of the screen.

If a background portion of the logo image is not stored to the storage unit 122, the signal generation unit 123 generates a background image of the logo image in a monochromatic or a predetermined pattern and provides the background image to the graphic processing unit 124. For example, if the display unit 110 supports a RGB mode, the signal generation unit 123 provides the background information, “R=0, G=0, B=1”, to the graphic processing unit 124 such that the background image of the logo image is displayed in a blue color even if the storage unit 122 does not store the background image.

According to another exemplary embodiment of the present invention, a message indicating that normal booting of the display apparatus 200 is in progress may be displayed. That is, the storage unit 122 may store a message indicating booting information, and a message indicating that booting is in progress, such as “booting” and “Initializing”, is displayed on the display screen along with the logo image according to the synchronization signal of the signal generation unit 123. Such a message may be displayed or not by user's setting or changed by the user.

The display apparatus 20 may further comprise a video processor (not shown) and an audio processor (not shown).

The video processor (not shown) performs separation, synchronization, and decoding of video signal, and the audio processor (not shown) separates audio signal from multimedia contents, decodes the audio signal, converts the audio signal into analog signal, and provides the analog signal to an audio output unit (not shown).

The components described above may be electrically connected to one another through a BUS 10 for mutual interface.

Although the components are integrated in a hardware level in the above exemplary embodiment, the components may be configured separately in a hardware level or vice versa.

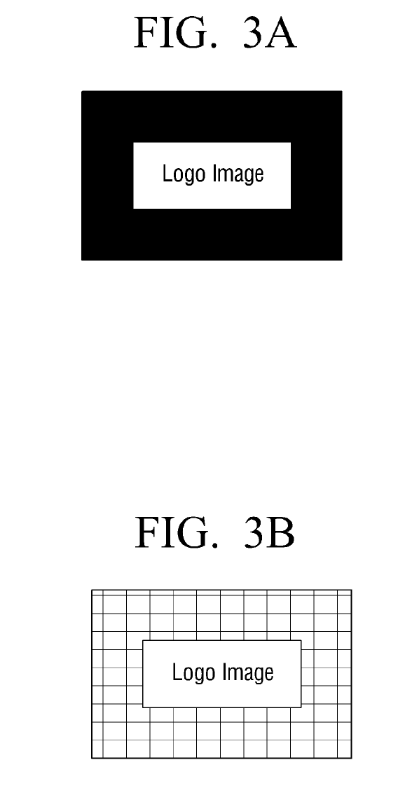

FIGS. 3A and 3B are views illustrating a method for displaying an image according to an exemplary embodiment of the present invention.

Referring to FIG. 3A, if a pre-stored logo image does not include a background portion or if a pre-stored logo image includes a background portion but the logo image is greatly changed due to scaling, the background may be processed in a monochromatic pattern based on the background information of the logo image.

Referring to FIG. 3B, a background image is provided in a predetermined pattern according to given information. Although the background image is displayed in a grid pattern, this is merely an example. The background image may be displayed in various patterns such as a dot pattern, a shaded pattern, and a zigzag pattern according to brief position information.

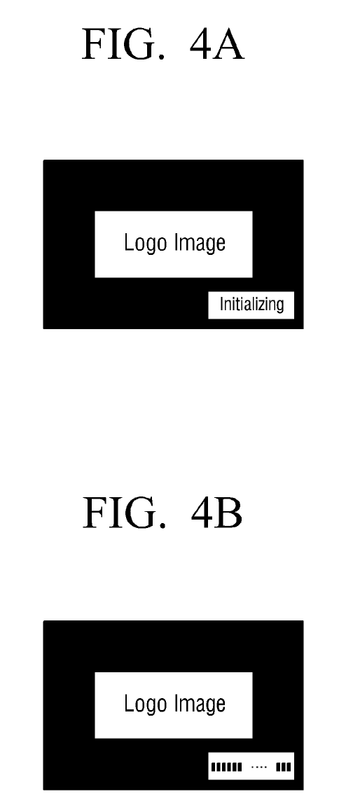

FIGS. 4A and 4B are views illustrating a method for displaying an image according to another exemplary embodiment of the present invention.

Referring to FIGS. 4A and 4B, a booting indication that normal booting is in progress is displayed along with the logo image of FIG. 3A. This example can be implemented with only pre-stored booting indication information and position information. Also, in some situation, a message indicating that normal booting is in progress, such as “Booting”, may be displayed.

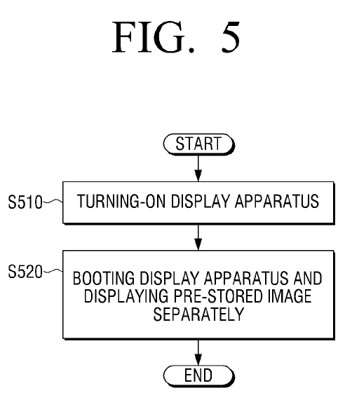

FIG. 5 is a flowchart illustrating a method for controlling a display apparatus according to an exemplary embodiment of the present invention.

Referring to FIG. 5, if a display apparatus is turned on (S510), a boot up of the display apparatus and a display of a pre-stored image are separately performed (S520). The pre-stored image may be a logo image (trademark or commercial image) of a set manufacturer or may be a symbol, emblem, mark, ideogram in some situation.

More specifically, if the display apparatus is turned on, a control signal to proceed with the boot up and a control signal to display the pre-stored logo image are separately generated such that the logo image is displayed regardless of the boot up.

Also, the pre-stored logo image may be graphic-processed and provided to a display screen. The graphic-process refers to a process of enlarging or reducing the size of the logo image or generating a background image. That is, the pre-stored logo image may be a complete image including a background image or a partial image, such as a figure or a letter, excluding a background image.

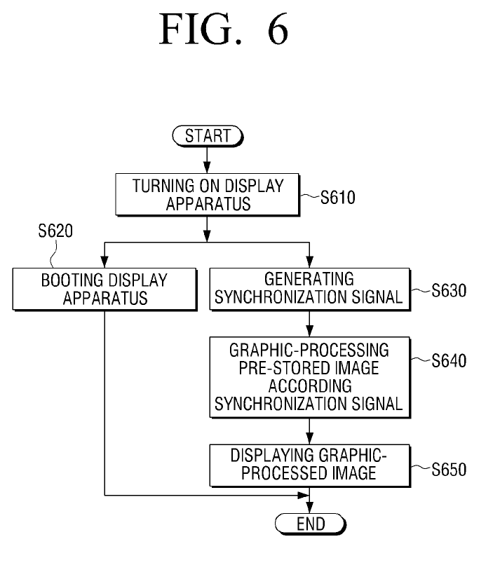

FIG. 6 is a flowchart illustrating a method for controlling the display apparatus of FIG. 5 in detail. For the convenience of explanation, the same portions as those of FIG. 5 will not be described in detail.

Referring to FIG. 6, if the display apparatus is turned on (S610), booting operation for the display apparatus is performed (S620).

Also, a synchronization signal is generated to display a pre-stored image separately from the booting operation (S630).

More specifically, respective circuit units in the display apparatus are initially driven and operated/controlled through the CPU. That is, if the display apparatus is turned on, the CPU executes a boot loader program to check function statuses of respective components of the display apparatus, and loads an operating system onto a memory to boot the display apparatus. For example, a flash memory stores a boot code such as a basic input output service (BIOS) to boot a system, and a main memory stores data or command processed by processors and may be implemented as a DRAM. In response to a system initialization signal, a corresponding boot code is read out from the flash memory and then is copied into the main memory such that the system initialization is performed.

The pre-stored image is graphic-processed according to the synchronization signal generated in operation S630 (S640).

The pre-stored image may be a complete image or a partial image which is displayed when the display apparatus is turned on. For example, the image displayed when the display apparatus is turned on may include at least one of a letter, a figure and a background. Among these, only the letter and the figure may be pre-stored. In this case, the background may be generated and displayed separately from the pre-stored image. Detailed description thereof will be provided later.

The pre-stored image may be compressed and stored in various compression methods. For example, the image may be compressed in a non-loss compression method such as run length encoding (RLE) (LZW algorithm). Also, the image may be compressed in runtime length decoding (RLD) or Entropy compression method.

The synchronization signal generated in operation S630 controls the storage unit storing the image and the graphic processing unit to graphic-process the image. Accordingly, the pre-stored image can be displayed separately from the booting operation of the display apparatus.

The graphic-process refers to a process of scaling the stored image and generating a background image. For example, a scalor (not shown) interpolates image data according to various resolutions such as VGB, SVGA, XGA, SXGA, UXGA, HD-TV to generate a new image suitable for the screen size, and also performs gamma correction, on-screen display (OSD), filtering, brightness/contrast adjustment.

In addition to the synchronization signal, signals regarding background information of the screen on which the pre-stored image is to be displayed, position information regarding where an image is to be displayed on the display screen, and size information of the display screen may be generated in operation 5630. The graphic processing unit graphic-processes the background image using the generated background information and scales the compressed image using the size information of the screen.

If a background portion of the image is not pre-stored, the background information is generated to generate a background in a monochromatic or a predetermined pattern and is provided to the graphic processing unit.

According to another exemplary embodiment of the present invention, a message indicating that normal booting of the display apparatus is in progress. That is, a message indicating booting information may be pre-stored or the message indicating that booting is in progress, such as “Booting” or “Initializing” may be displayed along with the logo image according to the synchronization signal generated in operation 5630. The message may be displayed or not by user's setting or changed.

The image graphic-processed in various methods in operation S640 is displayed on the screen (S650).

Accordingly, the user can see the logo image at the same time of turning on the display apparatus and acknowledges that the display apparatus is being normally booted by seeing the logo image.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus comprising:
a display unit; and
a control unit which separately performs a boot up of the display apparatus and a display of a pre-stored image if the display apparatus is turned on.

2. The display apparatus as claimed in claim 1, wherein the control unit comprises:
a central processing unit (CPU) which initiates the boot up if the display apparatus is turned on;
a storage unit which stores the image;
a signal generation unit which generates a synchronization signal if the display apparatus is turned on; and
a graphic processing unit which graphic processes the image stored in the storage unit according to the synchronization signal and provides the image to the display unit.

3. The display apparatus as claimed in claim 2, wherein the graphic processing unit enlarges or reduces a size of the image and provides the image to the display unit.

4. The display apparatus as claimed in claim 2, wherein the image includes at least one of a letter, a figure, and a background.

5. The display apparatus as claimed in claim 3, wherein the signal generation unit generates a signal regarding at least one of background information of a screen on which the image is to be displayed and position information indicating where the image is to be displayed on the screen, and provides the signal to the graphic processing unit.

6. The display apparatus as claimed in claim 1, wherein the image comprises a logo image.

7. A control method of a display apparatus, the control method comprising:
turning on the display apparatus; and
separately performing a boot up of the display apparatus and a display of a pre-stored image.

8. The control method as claimed in claim 7, wherein the display of the pre-stored image comprises:
generating a synchronization signal when the display apparatus is turned on; and
graphic processing and displaying the pre-stored image according to the synchronization signal.

9. The control method as claimed in claim 8, wherein the graphic processing operation enlarges or reduces a size of the image.

10. The control method as claimed in claim 8, wherein the image includes at least one of a letter, a figure, and a background.

11. The control method as claimed in claim 10, wherein the generating the synchronization signal comprises generating a signal regarding at least one of background information of a screen on which the image is to be displayed and position information indicating where the image is to be displayed on the screen.

12. The control method as claimed in claim 7, wherein the image comprises a logo image.

13. A start up method of a display apparatus, the method comprising:
turning on the display apparatus;
booting up the display apparatus; and
displaying a pre-stored image, wherein both the booting up and the displaying of the pre-stored image, are performed substantially simultaneously.

14. The start up method of claim 13, wherein the booting up and the displaying are performed substantially simultaneously based on a synchronization signal.

15. The start up method of claim 14, wherein both the booting up and the displaying are initiated by the synchronization signal.

16. A display apparatus comprising:
a display unit; and
a first processor which boots up the display apparatus in a boot up after the display apparatus is turned on; and
a second processor processes an image stored in a storage unit,
wherein the second processor processes the image to display the image on the display unit during the boot up.

17. The display apparatus of claim 16, wherein both the first processor booting up the display apparatus and the second processor processing the image are initiated by a synchronization signal.
